(19) United States
(12) Patent Application Publication
(10) Pub. No.: US 2013/0255645 A1
(43) Pub. Date: Oct. 3, 2013

(54) INTERNAL COMBUSTION ENGINE WITH IMPROVED TANK CLEANING

(71) Applicants: Philippe Grass, Regensburg (DE); Manfred Weigl, Sinzing / Viehhausen (DE)

(72) Inventors: Philippe Grass, Regensburg (DE); Manfred Weigl, Sinzing / Viehhausen (DE)

(21) Appl. No.: 13/994,572

(22) PCT Filed: Dec. 12, 2011
(86) PCT No.: PCT/EP2011/072464

§ 371 Date: Jun. 14, 2013

(30) Foreign Application Priority Data
Dec. 15, 2010 (DE) 10 2010 054 668.2

(51) Int. Cl. F02M 25/08

(52) U.S. Cl. CPC F02M 25/0836
USPC 123/520

(57) ABSTRACT

An internal combustion engine having a fuel tank, a fuel vapor store for storing fuel vapors that escape from the fuel tank, having a connecting line between the fuel vapor store and an air intake tract to conduct fuel vapors from the fuel vapor store into the air intake tract during a regeneration phase, a valve arranged in the connecting line, an aeration line for the fuel vapor store, and having a valve arranged in the aeration line for controlling the aeration of the fuel vapor store. A purge air pump arranged in the aeration line is integrated into the valve unit for controlling the aeration of the fuel vapor store. Effective purging or regeneration of the fuel vapor store is attained even when no negative pressure or only a low negative pressure is provided by the air intake tract.

### CROSS REFERENCE TO RELATED APPLICATION

This is a U.S. national stage of application No. PCT/EP2011/072464, filed on 12 Dec. 2011. Priority is claimed on German Application No.: 10 2010 054 668.2 filed 15 Dec. 2010, the content of which is incorporated here by reference.

### BACKGROUND OF THE INVENTION

1. Field of the Invention

The present invention relates to an internal combustion.

2. Description of the Prior Art

Modern motor vehicles now generally have a tank venting system. In this system, the fuel vapors formed in the fuel tank of the motor vehicle are adsorbed in a fuel vapor store, which is generally an activated carbon canister. The fuel vapor store is connected to the air intake section of the internal combustion engine by a connecting line (vent line). In the vent line there is a tank vent valve, by which the fuel vapor store can be either connected to the intake section or separated therefrom. From time to time, the fuel vapor store laden with fuel vapors must be regenerated. This is accomplished by a procedure in which the tank vent valve is opened, and the absorbed fuel vapors flow from the fuel vapor store into the intake section and participate in the combustion process of the internal combustion engine.

Internal combustion engines designed in this way are known from DE 10 2007 008 119 B4 and DE 10 2007 013 993 A1, for example.

However, there are also internal combustion engines which, in addition, have a special air admission line for the fuel vapor store and a valve unit arranged in the air admission line for controlling air admission to the fuel vapor store. When this valve unit is opened, the air admission line for the fuel vapor store is connected to the atmosphere, allowing ambient air to flow into the fuel vapor store and remove the fuel vapors present therein via the vent line.

In the procedure described above, the fuel vapors are thus drawn in and fed to the combustion air by a vacuum. For this purpose, engine operating states in the throttled range are required since it is only then that there is a sufficient vacuum available for removal by suction or purging. Hitherto, this procedure was sufficient to purge the fuel vapor store, particularly in the test cycles prescribed for the homologation of vehicles, with an efficiency such that the subsequent test for evaporation losses could be passed.

However, the pressure to reduce fuel consumption has led to the introduction in motor vehicles of measures that decisively reduce the time in which a sufficient vacuum is available. These include, for example, a start/stop function, in which the engine is switched off when the vehicle is stationary, the use of hybrid drives, in which idling is almost completely avoided and part-load operation is largely avoided, and engine power control by a variable valve gear, in which the function of the throttle valve is largely or even completely eliminated.

To improve the efficiency with which the fuel vapor store is purged, heated activated carbon filters or latent heat stores in the activated carbon have already been used. However, these methods are complex.

An internal combustion engine is known from JP 2002 115 605 A. In this case, a purge air pump is arranged in the air admission line for the fuel vapor store, said pump supplying the fuel vapor store with purge air for cleaning the latter. The purge air pump and the valve unit for controlling air admission to the fuel vapor store are arranged separately from one another.

DE 39 35 209 A1 discloses an adsorption filter for fuel vapors in which a ventilation device is arranged at the outlet of the filter, said ventilation device drawing the petroleum vapors through the adsorption filter during refueling. Here, the ventilation device can be designed as a subassembly which can be attached to the filter.

U.S. Pat. No. 6,283,097 B1 discloses a leak detection system in which a pump puts the tested vapor emission space under pressure during a test. In this case, this pump can be designed as a constructional unit together with a valve.

US 2007/189907 A1 discloses an internal combustion engine in which a purge air pump and a valve unit are provided but in which the impeller axis of the purge air pump is arranged parallel to the valve body of the valve unit.

U.S. Pat. No. 6,283,097 B1 describes an internal combustion engine having a purge air pump and a valve unit, which are arranged in a common housing but, in this case, the impeller axis of the purge air pump is likewise not arranged as an extension of the valve body of the valve unit.

### SUMMARY OF THE INVENTION

It is an object of one embodiment of the present invention to provide an internal combustion engine of the type stated in which particularly good cleaning of the fuel vapor store can be ensured at low cost.

According to one embodiment of the invention, cleaning or purging the fuel vapor store is performed using a purge air pump that produces a sufficiently large pressure difference, such that in addition to the vacuum of the air intake section or instead of such a vacuum, largely unproblematic cleaning or purging of the fuel vapor store can be carried out, this being performed with the aid of ambient air supplied. Since the purge air pump used according to one embodiment of the invention is integrated into the valve unit that is used for controlling air admission to the fuel vapor store, the arrangement of the pump gives rise to fewer additional costs since the costs for the pump itself, the amount of cabling and the effort involved in installation and the gas connections can be reduced. Since, owing to its integration into the valve unit, the pump does not require a dedicated housing, the only costs that arise are, in particular, those for the impeller of the pump and the drive thereof (electric motor). The costs and assembly effort for the electrical connections are minimized since, for example, the plug-in connection which is already present for the functions of the valve unit has only to be expanded by additional pins for the pump control system. Additional expense for the gas connections is eliminated completely since connections to the atmosphere and to the fuel vapor store are already present.

In all cases, the valve unit and the purge air pump have a common housing and form one constructional unit, thus making it possible to reduce the additional outlay for the arrangement of the purge air pump to a large extent, as explained above.

A valve unit of this kind has a valve body that interacts with a valve seat and, when it rises from the valve seat, establishes a connection between the air admission line and the environment, allowing ambient air to flow into the air admission line. Here, the closure of the valve is preferably accomplished by a spring that presses the valve body against the valve seat again when a corresponding pressure balance has been achieved. According to one embodiment of the invention, the purge air pump is arranged as an extension of the valve body controlling the purge air supply into the air admission line. Here, the axis of an impeller of the purge air pump is arranged as an extension of the axis of the valve body, and the drive (electric motor) of the pump is situated on the opposite side of the impeller from the valve body.

As regards the valve unit arranged in the air admission line for the fuel vapor store, it is configured to control venting of the fuel vapor store and to control air admission to the fuel vapor store (and hence to/of the fuel tank). During refueling, for example, the air admission line is thereby connected to the atmosphere, allowing a corresponding excess pressure to be dissipated.

As a drive, the purge air pump preferably has an electric motor, further promoting the achievement of a low-cost and simple solution.

A simple radial pump, the impeller of which can be integrated in a particularly simple manner into the valve housing, is preferably used.

If the valve unit is additionally used to control the venting of the fuel vapor store (and hence of the fuel tank), it preferably additionally has a control element that raises the valve body mechanically from the seat in order to vent the fuel vapor store. In one specific embodiment, this control element is designed as a diaphragm. The diaphragm is acted upon by a control chamber into which a branch of the air admission line opens. If, therefore, there is an excess pressure in the air admission line, the excess pressure present in the control chamber presses the diaphragm against the valve body and raises it from the seat, thus enabling the air admission line to be vented to the environment.

A valve unit of this kind is particularly suitable for the integration of a purge air pump, in particular of a simple radial pump. Since the required pressure difference for an adequate volume flow of the order of 50 l/h need only be about 50 mbar, it is possible to select a diameter for the radial pump similar to that for the control element (the diaphragm) of this valve unit, and therefore integration of the pump function leads to a very advantageous construction.

Integrating the radial pump into the valve unit results in cost advantages, both in the components themselves and in terms of integration into the vehicle.

The purge air pump is preferably integrated into the central valve unit of a valve system, made by the applicant, used for air admission and venting, which is sold under the name NVLD (Natural Vacuum Leak Detection). The central component of this system is ideally suited for additionally taking on the pump function.

### BRIEF DESCRIPTION OF THE DRAWINGS

The invention is explained in detail below by means of an illustrative embodiment in combination with the drawing, in which:

FIG. 1 is a schematic illustration of an internal combustion engine having a fuel system in accordance with the prior art (without a purge air pump);

FIG. 2 is an enlarged sectioned illustration of the valve unit used in the system of FIG. 1;

FIG. 3 is a schematic illustration of an internal combustion engine having a fuel system in accordance with one embodiment of the invention; and

FIG. 4 is a sectioned illustration of a valve unit into which a purge air pump is integrated.

### DETAILED DESCRIPTION OF THE PREFERRED EMBODIMENTS

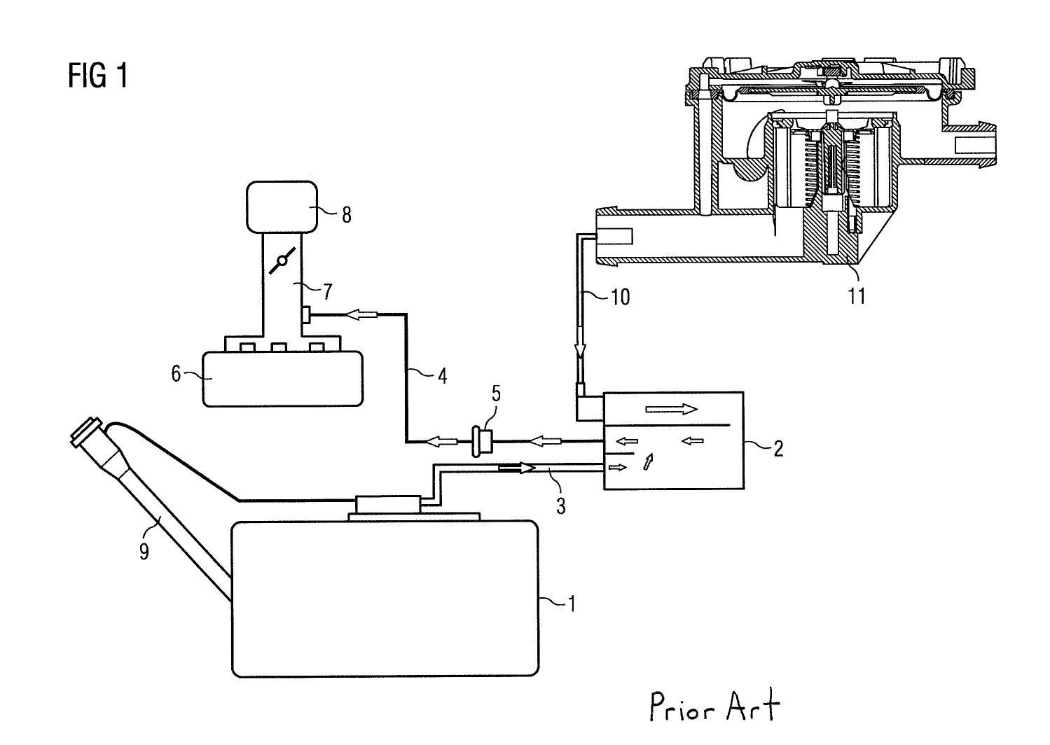

FIG. 1 shows schematically an internal combustion engine 6 having an intake air section 7 and an air filter 8. The internal combustion engine 6 is provided with a fuel tank 1 having a filler neck 9. A line 3 leads from the fuel tank 1 to a fuel vapor store 2, which can be a store filled with activated carbon, for example. Leading off from the fuel vapor store 2 to the air intake section 7 of the internal combustion engine 6 is a connecting line, in which a vent valve 5 is arranged. Also connected to the fuel vapor store 2 is an air admission line 10, which leads to a valve unit 11 that controls air admission to and venting of the fuel vapor store 2 and hence of the fuel tank 1.

The system illustrated in FIG. 1 belongs to the prior art. During operation, the fuel vapors collect in the fuel vapor store 2 and are absorbed by the activated carbon arranged in the store 2. When the store 2 is to be regenerated, the vent valve 5 is opened, establishing a connection between the fuel vapor store and the air intake section 7 of the internal combustion engine 6. The fuel vapor store 2 is purged or regenerated by ambient air that flows in via the air admission line 10 when the valve unit 11 is open, due to the vacuum in the air intake section 7, and the fuel vapors discharged into the air intake section 7 are included in combustion.

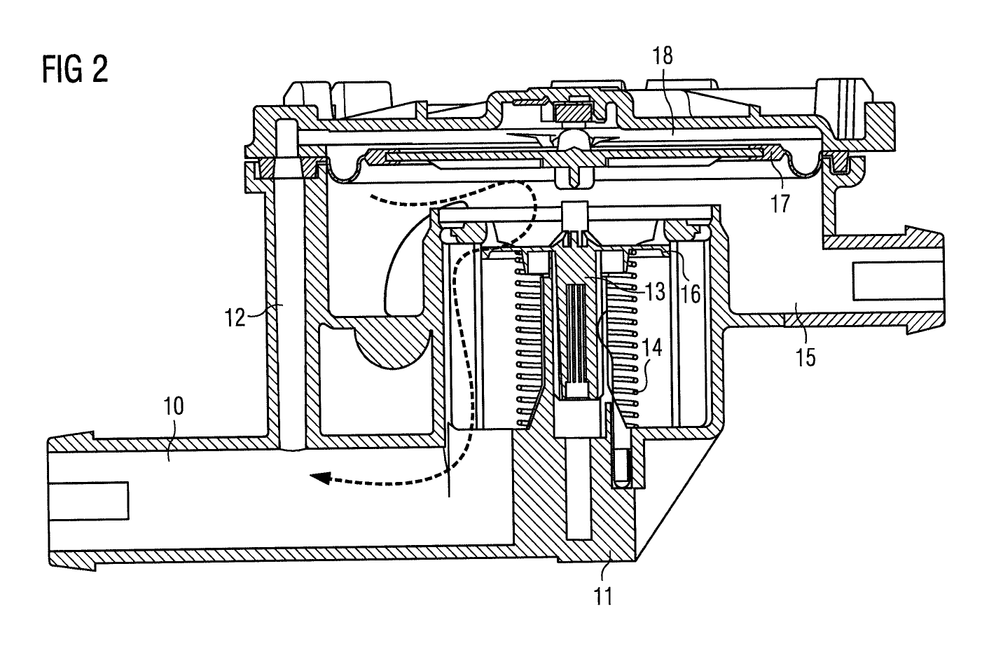

FIG. 2 shows the valve unit 11 in an enlarged sectioned illustration and in the open state used to admit air to the fuel vapor store 2 and hence to the fuel tank 1. The valve unit 11 has a housing, in which a control chamber 18 and an air chamber 15 are arranged, these being separated from one another by a control element in the form of a diaphragm 17. The control chamber 18 is connected to the air admission line 10 by a branch 12. A valve body 13, which can be moved up and down, interacts with a valve seat 16, closing and opening a connection between the air chamber 15 and the air admission line 10. The valve body 13 is opened by a pressure difference between the air chamber 15 and the air admission line 10, as shown in FIG. 2, since the pressure in the air chamber 15, which is filled with ambient air, is greater than the pressure in the air admission line 10. Thus, ambient air flows out of the air chamber 15 into the air admission line 10 and to the fuel vapor store 2, thus allowing the regeneration process described above to be carried out. When there is no longer a pressure difference, the valve body 13 is pressed against the valve seat 16 again by a spring 14, thereby interrupting the connection between the air chamber 15 and the air admission line 10.

Moreover, the valve body 13 is also moved mechanically. For this purpose, use is made of the abovementioned control element 17 in the form of a diaphragm. During refueling, the pressure in the air admission line 10 rises sharply, with the result that the control element 17 is pushed downward by the increased pressure, which also penetrates into the control chamber 18, and strikes the valve body 13, moving the latter downward, with the result that the connection between the air chamber 15 and the air admission chamber 10 is opened wide. The air admission line 10 can now be vented to atmosphere via the air chamber 15.

The valve unit 11 can also have further functions which are not described here.

The invention makes use of the presence of this valve unit 11 and integrates a purge air pump into the valve unit to ensure improved purging or regeneration of the fuel vapor store, especially when the vacuum made available by the air intake section 7 of the internal combustion engine 6 is inadequate.

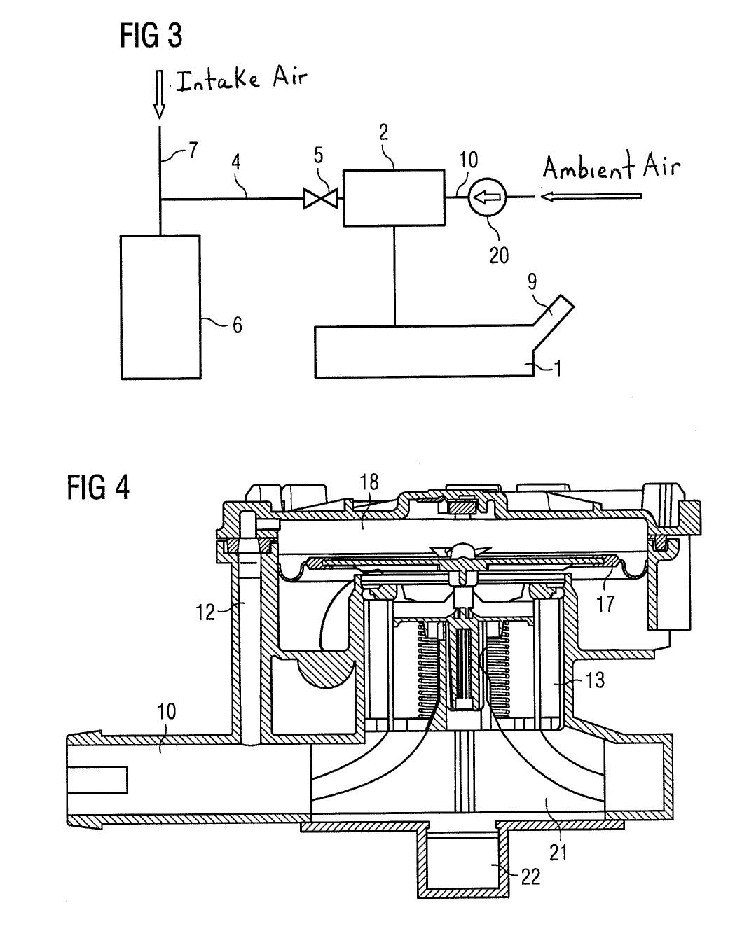

FIG. 3 shows schematically a fuel system which corresponds essentially to that in FIG. 1 and in which a purge air pump is integrated into the valve unit in the air admission line 10. This valve unit with an integrated purge air pump is provided with reference sign 20. If the fuel vapor store 2 is now to be regenerated or purged by opening the vent valve 5, the valve unit 20 opens the connection between the air chamber 15 and the air admission line 10, and the purge air pump is put into action, ensuring that the fuel vapor store 2 is supplied with ambient air.

FIG. 4 shows the combined valve/purge air pump unit 20. Here, the valve unit is essentially of exactly the same design as the unit shown in FIG. 2. Only the air admission line 10 is expanded to form a chamber under the valve body 13, in which chamber the impeller 21 of a radial pump driven by an electric motor 22 situated below it is arranged. In this arrangement, the shaft of the impeller 21 is provided as an extension of the valve body 13. If the valve body 13 now opens the connection between the air chamber 15 and the air admission line 10, the radial pump is put into action, and ambient air is delivered by the pump to the fuel vapor store 2, which is in this way purged or regenerated without the need for a corresponding vacuum from the air intake section 7. By virtue of the fact that the purge air pump is integrated into the valve unit, a simple and low-cost solution is achieved.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. An internal combustion engine comprising:
an air intake section of the internal combustion engine;
a fuel tank;
a fuel vapor store coupled to the fuel tank configured to store fuel vapors from the fuel tank;
a connecting line between the fuel vapor store and the air intake section of the internal combustion engine configured to pass fuel vapors from the fuel vapor store to the air intake section;
a valve arranged in the connecting line;
an air admission line for the fuel vapor store; and
a valve unit, having a valve body and a seat, arranged in the air admission line, and configured to control admission of air into the to the fuel vapor store;
a purge air pump configured to supply purge air to the fuel vapor store arranged in the air admission line for the fuel vapor store, the purge air pump integrated into the valve unit for controlling the admission of air to the air admission line and the fuel vapor store;
a common housing for the valve unit arranged in the air admission line and the purge air pump; and
a control element of the valve unit configured to raise the valve body mechanically from the seat to vent the fuel tank,
wherein the purge air pump is integrated into the valve unit arranged in the air admission line and configured to control admission of air to the fuel vapor store, and
wherein the purge air pump is arranged with its impeller axis as an extension of the valve body of the valve unit configured to control the purge air into the air admission line.

9. The internal combustion engine as claimed in claim 8, wherein the purge air pump has an electric motor configured as a drive.

10. The internal combustion engine as claimed in claim 8, wherein the purge air pump is a radial pump.

11. The internal combustion engine as claimed in claim 10, wherein the impeller of the radial pump has a diameter that substantially corresponds to a diameter of the control element of the valve unit.

12. The internal combustion engine as claimed in claim 8, wherein the purge air pump is integrated into a central valve unit of a system configured to control air admission to and venting of a fuel tank.

13. The internal combustion engine as claimed in claim 8, wherein the fuel vapors from the fuel vapor store are passed to the air intake section during a regeneration phase of the fuel vapor store.
